(19) United States
(12) Patent Application Publication
(10) Pub. No.: US 2016/0251874 A1
(43) Pub. Date: Sep. 1, 2016

(54) PANEL CLAMPS FOR FENCES AND BARRIERS

(71) Applicants: John Schopf, Thornbury (AU); Manfred Schopf, Thornbury (AU)

(72) Inventors: John Schopf, Thornbury (AU); Manfred Schopf, Thornbury (AU)

(21) Appl. No.: 15/053,727

(22) Filed: Feb. 25, 2016

Related U.S. Application Data
(62) Division of application No. 12/997,988, filed on Jun. 7, 2011, now abandoned.

(30) Foreign Application Priority Data
Jun. 14, 2008 (AU) 2008903013

(51) Int. Cl. E04H 17/16; F16B 2/06; F16M 13/02

(52) U.S. Cl. CPC E04H 17/168; E04H 17/166; F16M 13/02; F16B 2/06

(57) ABSTRACT

Clamps are provided for supporting panels, such as glass panels. One aspect of the clamps disclosed is that the clamps have two parts that can be slid into clamping engagement with each other. Another aspect is that the clamps comprise a fastener for securing the clamp to a structure is received in an internal cavity in the clamp. This cavity is concealed from external view when the clamp is in use, but can be exposed for access to the fastener by sliding the two clamp halves out of engagement.

### CROSS-REFERENCE TO RELATED APPLICATIONS

This application is a divisional of U.S. patent application Ser. No. 12/997,988, filed on Jun. 7, 2011, which is a U.S. national stage patent application of PCT/IB2009/005919, filed on Jun. 14, 2009, which claims priority to Australian patent application no. 2008903013, filed on Jun. 14, 2008. Each aforementioned application is incorporated herein by reference in its entirety.

### FIELD OF THE INVENTION

The invention described here relates to improved clamps for panels, with particular reference to clamps for use in fences and barriers.

### BACKGROUND

FIG. 1 is a perspective view of a portion of a fence 1 that comprises a plurality of panels 2 arranged end-to-end with small gaps 3 therebetween, each panel being held in a vertical plane by two clamps 4, with clamps 4 being set into a supporting surface 5. Fences of this type, typically with panels 2 being made of glass or a transparent plastic (for example those sold under the trade marks Lexan and Perspex), are widely used as security fences for swimming pools, to mark boundaries of eating areas of restaurants and in like applications. They have sometimes been used as balustrades on buildings.

The appearance and the speed and ease of erection of fence 1 are dependent in part on the design of the panel-supporting clamps 4, as of course is the structural integrity and safety of fence 1. Several clamps applicable to such fences, and to certain other fences also, are described below. These are believed to be useful additions to the choices available to designers, when judged by the combination of appearance, erection ease, and speed, and by the safety and integrity they offer.

Particular advantages of the clamps disclosed herein is that they can avoid or minimize the obtrusive sight of fasteners on the clamps' exteriors, and are convenient and adapted for comparatively rapid installation compared to some more conventional types

### SUMMARY OF THE INVENTION

The invention offers a useful alternative to conventional clamps such as those in which two clamp parts are held together by through bolts or screws for example.

According to the invention there is provided in one aspect a clamp securable to a panel said clamp comprising separable first and second clamping means, wherein:

said first and second clamping means are adapted to in use press against opposing faces of the panel; and

said first and second clamping means are movable into engagement with each other for use and adapted to thereafter resist separation from each other by friction between a surface of the first clamping means and a surface of the second clamping means.

Preferably, said first and second clamping means are movable slidingly into interlocking engagement.

Said clamping means may comprise a rigid part and an elastic part that in use lies between the rigid part and a said face of the panel and in use of the clamp is compressed whereby said panel is clamped and a force is developed that urges together said surface of the first clamping means and said surface of the second clamping means.

Preferably, it is arranged that movement of said first and second clamping means into engagement with each other requires relative movement at an acute angle to a surface of a panel clamped between said first and second d clamping means whereby movement of said first and second clamping means into engagement with each other compresses said elastic part. Some driving together of the two clamping means is generally required to complete secure attachment of a clamp to a panel, and the direction of driving can be substantially parallel to the panel surface which is convenient and reasonably safe.

Said acute angle is preferably between 2 degrees and about 10 degrees, preferably between 2 degrees and about 7 degrees.

In one embodiment, one of the first and second clamping means is wedgingly receivable in the other. However, wedging action is not essential.

In preferred embodiments, the said surface of the first clamping means and the said surface of the second clamping means comprise one of a plurality of pairs of surfaces that in use of the clamp lie in contact with each other.

A clamp according to the invention may have a formation comprised in a said clamping means that is adapted to be in contact with a downwardly facing surface of the panel in use of the clamp to support the panel above a substrate or structure to which the clamp is secured.

Said formation may be adapted to be received in an opening in said panel or in a recess in an edge of the panel.

Said formation may comprise one of a pair of surfaces that in use of the clamp lie in contact with each other.

One class of clamps according to the invention is adapted to be grouted into a hole in a substrate and that permits disassembly and removal from said hole of at least one of said first and second clamping means when the panel is removed from the clamp.

In another aspect the invention provides a clamp having first and second clamping means adapted to engage each other so as to clamp a panel therebetween wherein one the first and second clamping means has a cavity therein partially bounded by a recess or opening within which at least one fastener assembly is receivable, the fastener assembly being adapted to secure said one of the first and second clamping means to a structure or substrate. This arrangement can make for convenience is securing clamps to structures or substrates.

A portion of the said at least one fastener assembly may be receivable in the cavity.

Preferably, upon assembly of the first and second parts together so as to clamp a panel therebetween the cavity is covered by the other of the first and second parts.

The invention further provides a barrier comprising a panel supported from below by at least one clamp and a railing secured to an upper edge of said panel by at least one clamp wherein a said clamp accords with any one of the embodiments disclosed herein. The barrier may be for example a swimming pool safety fence, or a balustrade for use on a deck or balcony.

The invention further provides a method for securing a panel to a structure or substrate comprising the steps of:

providing a clamp according to any one of the embodiments disclosed herein;

securing said clamp to a panel; and

securing said clamp to a structure or substrate.

It may be provided that said clamp is secured to said panel before said clamp is secured to said structure or substrate. This has been found to be convenient for installers of fences, balustrades and the like.

Other inventive aspects features and refinements of the invention are set out below in the following detailed description and in the claims and diagrams. These relate at least to the means whereby the clamp may be secured to a supporting surface or substrate, means whereby the clamp may be removed from a panel and from a supporting substrate, further aspects of design of the clamping means, methods of assembly of the clamp, and fences and other structures incorporating the clamp.

In this specification, including in the appended claims, the words “comprising” and “comprises” when used in relation to a set of elements integers features or steps are to be taken to indicate that the elements integers features or steps are present, but are not to be taken to preclude the possibility of other elements integers features or steps being present also.

### BRIEF DESCRIPTION OF THE SEVERAL VIEWS OF THE DRAWINGS

Preferred embodiments of the inventions will be further described in the following detailed description, by reference to the attached Figures, of which:

FIG. 1 is a perspective view of a portion of a fence having clamps of a type disclosed herein;

FIG. 2 is an elevation of a clamp according to the invention, as installed in a fence;

FIG. 3 is a side elevation of the clamp shown in FIG. 2, seen looking in the direction of arrow “A”;

FIG. 4 is a view from below of the clamp shown in FIG. 2;

FIG. 5 is a side elevation of a first part of the clamp shown in FIG. 2;

FIG. 6 is a front elevation of the clamp first part shown in FIG. 5, seen looking in the direction of arrow “B”;

FIG. 7 is a front elevation of a portion of a second clamp part of the clamp shown in FIG. 2;

FIG. 8 is a side elevation of the second clamp part as shown in FIG. 7, seen looking in the direction of arrow “C”;

FIG. 9 is a side elevation of the first and second clamp parts shown in FIGS. 5 and 8 respectively, when assembled together, the first clamp part being shown in chain dotted lines and the second clamp part portion being shown in full lines;

FIG. 10 is a side elevation of a portion of the clamp shown in FIG. 2, assembled and clamped to a panel;

FIG. 11 is a sectional view taken at station 11-11 in FIG. 10, the sectioned glass being treated as transparent;

FIGS. 12A, 12B, and 12C are a set of three views showing successive steps in the assembly to a panel of the clamp shown in FIG. 2;

FIGS. 13A and 13B comprise two schematic views illustrating the interlocking principle of the clamp shown in FIGS. 2-11 (FIG. 13A), and a possible variation of that interlocking principle (FIG. 13B);

FIG. 14 is a side elevation of two interlocking parts of a further clamp according to the invention incorporating the interlocking principle shown in FIG. 13B;

FIG. 15 is a side elevation of a further clamp according to the invention;

FIG. 16 is a perspective view of a first part of the clamp shown in FIG. 15;

FIG. 17 is a side elevation of the clamp first part shown in FIG. 16;

FIG. 18 is a perspective view of a second part of the clamp shown in FIG. 15;

FIG. 19 is a side elevation of the clamp second part shown in FIG. 18;

FIG. 20 is a side elevation of the first and second clamp parts shown in FIGS. 16 and 18 respectively, when assembled together;

FIG. 21 is a cross-sectional view of the assembly shown in FIG. 20, the section being taken at station “21-21”;

FIG. 22 is a perspective exploded view showing first (at left) and second (at right) parts of a yet further clamp according to the invention; and two mounting bolt/nut assemblies;

FIG. 23 is a front view of a portion of the second clamp part shown in FIG. 22;

FIG. 24 is a cross-sectional view of the second clamp part portion shown in FIG. 23, the section being taken at station “24-24”;

FIG. 25 is a view from below of the second clamp part shown in FIG. 23;

FIG. 26 is a perspective view of two clamping means of a further clamp according to the invention, disassembled;

FIG. 27 is a side elevation of a first part of the clamp shown in FIG. 26;

FIG. 28 is a front elevation of the clamp first part shown in FIG. 27, seen looking in the direction of arrow “AA”;

FIG. 29 is a plan view of the clamp first part shown in FIG. 27, seen looking in the direction of arrow “BB”

FIG. 30 is a front elevation of a second part of the clamp shown in FIG. 26;

FIG. 31 is a side elevation of the clamp second part shown in FIG. 30;

FIG. 32 is a cross-sectional view of the clamp second part shown in FIG. 30, the section being taken at station ‘32-32’;

FIG. 33 is a view from below of the clamp second part shown in FIG. 32;

FIG. 34 is a cross-sectional view of the clamp shown in FIG. 26, now assembled and holding a glass panel, the sectioning being at station “CC” for the first clamp part shown in FIG. 28 and at station “DD” for the second clamp part shown in FIG. 30;

FIG. 35 is a cross-sectional view of a further clamp according to the invention and incorporating the first clamp part shown in FIG. 28 and a modified form of the second clamp part shown in FIG. 30, the clamp being shown assembled and holding a glass panel, the sectioning being at station “CC” for the first clamp part shown in FIG. 28 and at station “DD” for the second clamp part shown in FIG. 30;

FIG. 36 is a schematic view illustrating the interlocking principle of the clamp shown in FIG. 26;

FIG. 37 is an exploded perspective view of a modified version of the clamp shown in FIG. 26;

FIG. 38 is an exploded perspective view of a further clamp according to the invention;

FIG. 39 is a cross section through a modified version of the clamp shown in FIG. 20, the section being on a plane marked ‘61-61’ on FIG. 20;

FIG. 40 is an elevation of a portion of a further fence comprising clamps according to the invention.

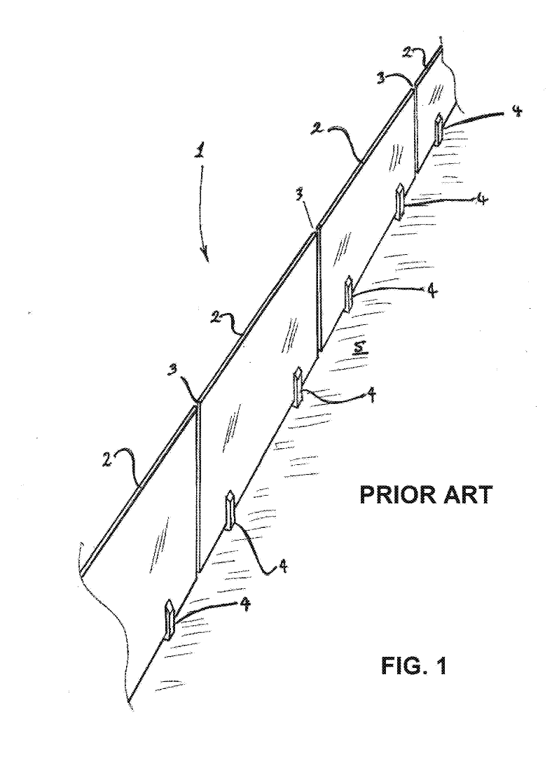

### DETAILED DESCRIPTION OF PREFERRED EMBODIMENTS

Several clamps according to the invention will be described below that are suitable for use as the clamps 4 in fence 1, using glass, transparent plastics or other sheet-type materials for the panels 2. Their applicability to other fence types and similar applications will also be discussed. Purely for convenience, glass panels only will be discussed, but this is not intended to imply any limitation on the panel materials to which any of the clamps may be applied.

An important class of extra but related application for at least some of the clamps to be described is to the securing of hand- and other rails to panels of glass and other materials of balustrades and the like.

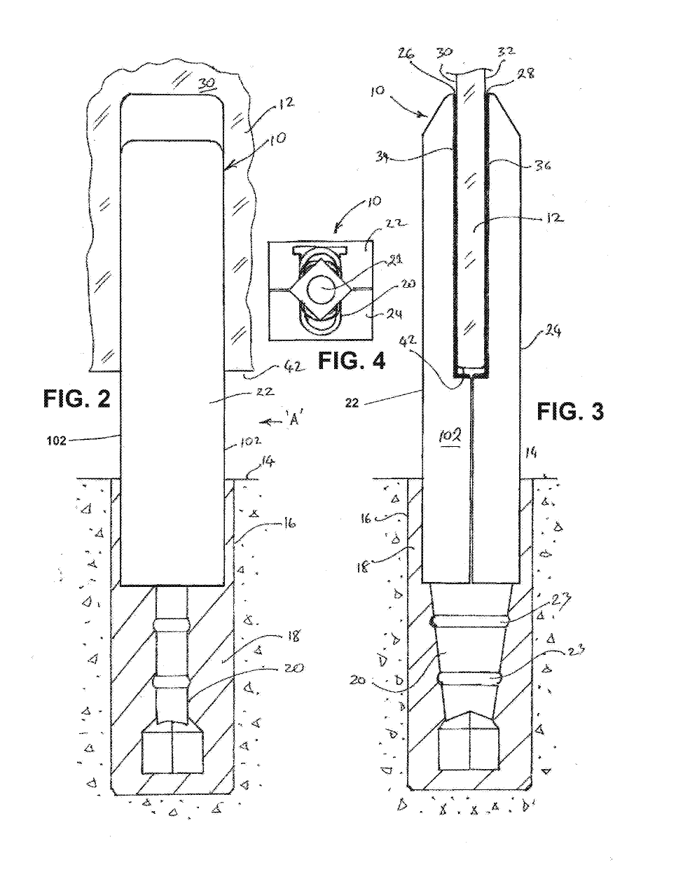

FIGS. 2 and 3 show a clamp 10 as it would be installed (in the role of a clamp 4) in a fence of the type of fence 1. Clamp 10 is shown supporting a glass panel 12 above a supporting surface 14. Clamp 10 is supported within a hole 16 in supporting surface 14 by settable grout 18, which could be for example cementitious or a resin-type such as an epoxy resin. Clamp 10 has a formation 20 at its lower end that is shaped so as to provide a positive engagement in the set grout 18.

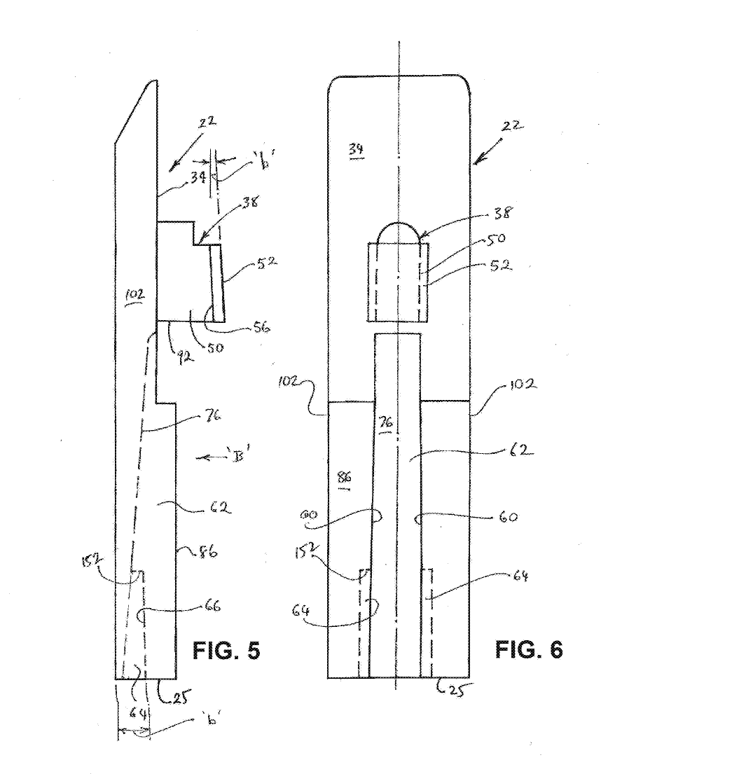

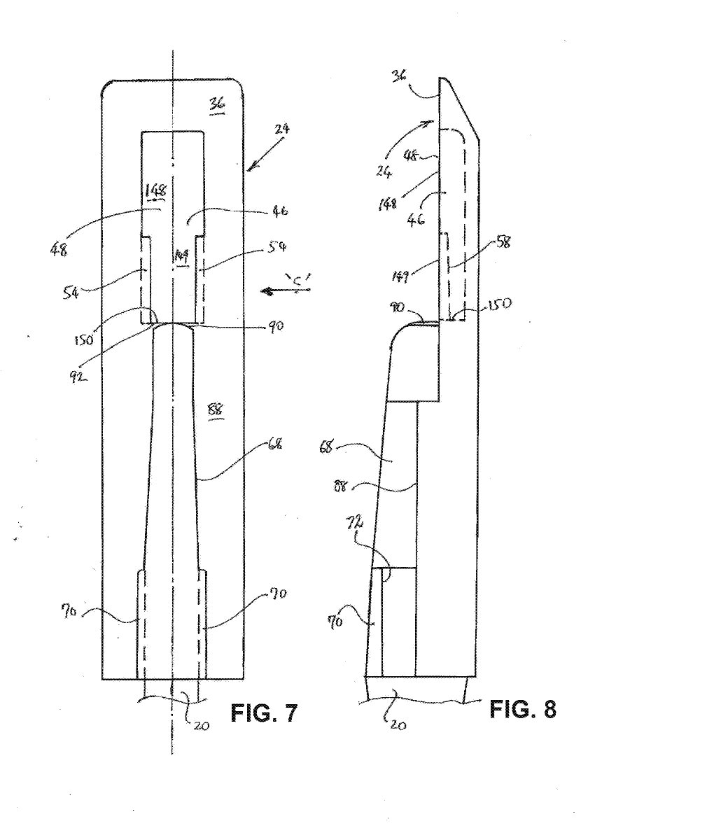

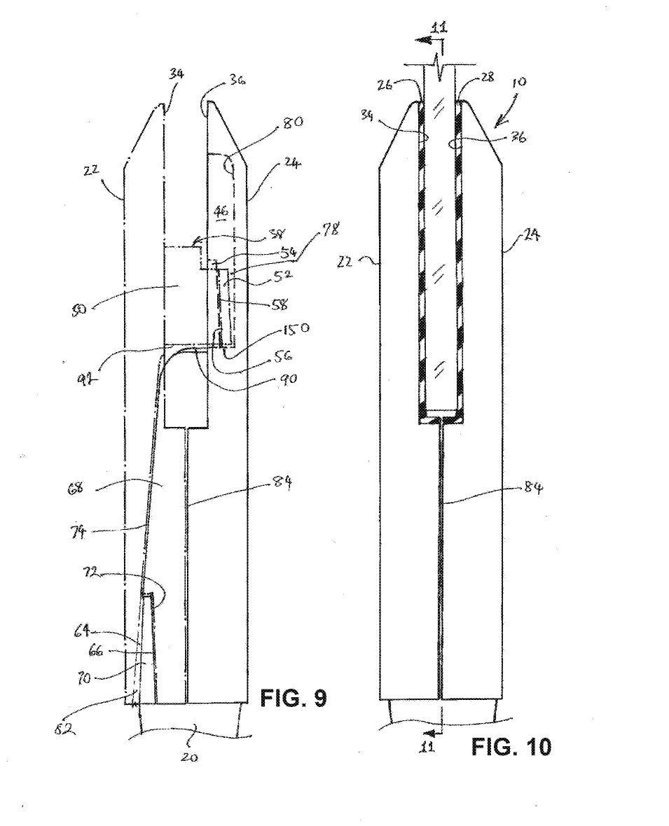

Clamp 10 comprises a first clamp part 22 and a second clamp part 24, and formation 20 is comprised in second part 24 as an integrally formed portion thereof. First clamp part 22 is shown in FIGS. 5 and 6 and second clamp part 24 is shown (excluding a portion of formation 20) in FIGS. 7 and 8. Clamp parts 22 and 24 in use interlock with each other in a way shown in FIG. 9 and explained below. Only parts 22 and 24 are shown in FIG. 9, to simplify the explanation. FIGS. 3 and 10 show the completed clamp 10, wherein panel 12 is held between first and second parts 22 and 24, with pad 26 between face 34 of part 22 and face 30 of panel 12, and pad 28 between face 32 of panel 12 and face 36 of part 24.

The elastic resilient pads 26 and 28 play an important part in the clamping action of clamp 10, and also prevent damage to glass panel 12 by preventing contact between panel 12 and faces 34 and 36 of clamp parts 22 and 24. Suitable grades of vulcanized natural rubber, synthetic rubber, or rubber-like polymer materials may be used for elastic resilient pads 26 and 28. Pads 26 and 28 may be secured to clamp parts 22 and 24 respectively using suitable adhesives before assembly of clamp 10. Pads 26 and 28 may be of the same or different materials as required. The combination of first clamp part 22 and pad 26 is referred to elsewhere in this specification as a “clamping means”, as is the combination of second clamp part 24 and pad 28. The remarks in this paragraph in relation to resilient elastic pads 26 and 28 are equally applicable to the corresponding pads of other clamps disclosed below.

Clamp parts 22 and 24 and pads 26 and 28 are so shaped and proportioned that when they are placed into interlocking engagement as shown in FIG. 9, panel 12 and pads 26 and 28 can only be accommodated between faces 34 and 36 when pads 26 and 28 are in compression. In this way, panel 12 is gripped by clamp 10.

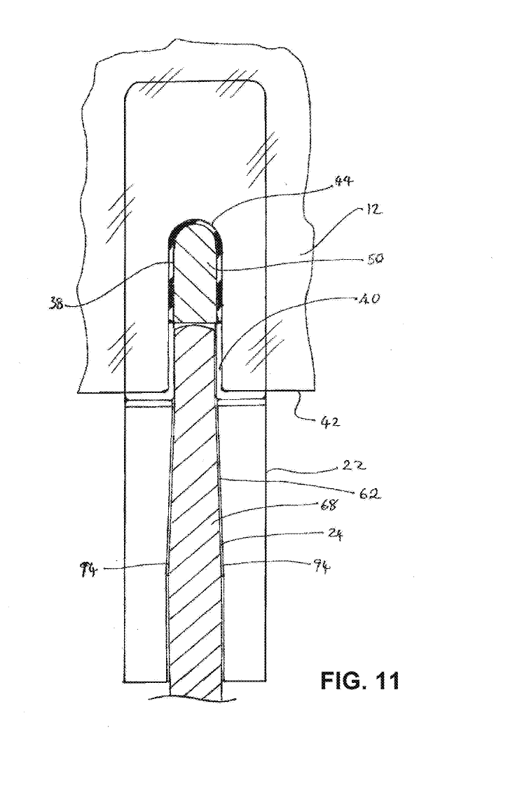

FIG. 11 shows how panel 12 is located longitudinally (i.e. in an along-fence direction) by clamp 10. A formation 38 extends from face 34 and is shaped to be received in a slot 40 extending inward from an edge 42 of panel 12. To avoid direct contact between formation 38 and panel 12, a resilient pad 44 of inverted “U” shape is placed over a portion of formation 38 before formation 38 is positioned in slot 40. Pad 44 is formed from a suitable material chosen from the options mentioned above for pads 26 and 28.

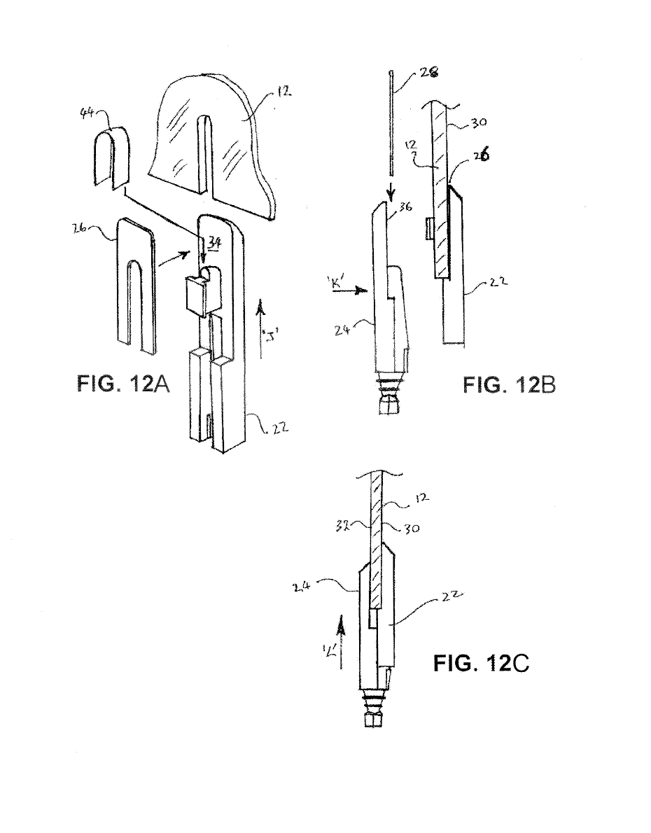

FIG. 12A-C shows steps in the assembly of clamp 10 onto a panel 12. FIG. 12A shows pad 26 is positioned against face 34 of part 22, pad 44 is positioned over formation 38, and then part 22 is slid in the direction of arrow “J” so that pad 44 and formation 38 are received in slot 40 of panel 12. Next, FIG. 12B shows pad 28 is positioned against face 36 of clamp part 24, and part 24 is moved in the direction of arrow “K” so that formation 38 of part 22 enters a cavity 46 in part 24 through an upper portion 148 of an opening 48 thereof. Finally, FIG. 12C shows part 24 is moved in the direction of arrow “L”, to complete the interlocking engagement of parts 22 and 24 in a way described further below, and therefore the clamping of panel 12. FIG. 12C requires compression of pads 26 and 28, and so involves the use of some force or impacts from a mallet or the like.

Reference is now made to FIGS. 5-8 and particularly FIG. 9. FIG. 9 shows how parts 22 and 24 are positioned relative to each other when clamp 10 is assembled, but with all other components omitted. Formation 38 comprises a web portion 50 protruding from face 34 and a flange 52 that extends on either side of web portion 50. Upper portion 148 of opening 48 is wide enough at its upper end for the flange 52 to pass through into cavity 46, but a lower portion 149 of opening 48 is less wide due to flanges 54 extending partially over cavity 46 and towards each other. Web 50 can pass between flanges 54 but flange 52 cannot do so. When the movement in FIG. 12C is made, each face 56 of flange 52 (there being one face 56 on each side of web 50) slides into contact with a face 58 of one of the flanges 54, and is held in such contact due to the compressing of resilient pads 26 and 28. Faces 56 are inclined at an angle “b” to face 34 (as seen in the side view of FIG. 5) and faces 58 are inclined at substantially the same angle to face 36 so that as formation 38 is moved downward in cavity 46, i.e. from portion 148 of opening 48 to portion 149, faces 34 and 36 of parts 22 and 24 are held substantially parallel to each other and move towards each other and pads 26 and 28 are progressively placed under increasing compression.

Below formation 38, part 22 has a tapered elongate cutaway 62 that becomes deeper and wider with increasing distance below formation 38, and extends through to a bottom surface 25 of part 22. Walls 60 define opposing sides of cutaway 62 and themselves have cutaway channels 64 at their lower ends which also extend to bottom surface 25. Faces 66 in cutaway channels 64 are parallel to faces 56 of flange 52, i.e. at the angle “b” to face 34 when seen in the side view of FIG. 5. An elongate rib 68 on part 24 is received in cutaway 62 when the clamp 10 is assembled as shown in FIG. 9. Rib 68 has laterally protruding flanges 70 at its lower end which, during the movement shown at FIG. 12C, enter cutaway channels 64. Faces 72 of flanges 70 are inclined at angle “b” to face 36 of part 24. Thus faces 72 and faces 66 can be in sliding contact as flanges 70 enter cutaway channels 64. So long as there is contact between faces 72 and 66 near the base of clamp 10 and faces 56 and 58 nearer the top of clamp 10, faces 34 and 36 are parallel to each other.

Parts 22 and 24 and pads 26 and 28 are so proportioned, and the materials of pads 26 and 28 are so chosen, that at the conclusion of the movement shown at FIG. 12C where the two parts 22 and 24 reach the relative positions shown in FIGS. 3, 9 and 10, the faces 56 and 58 are held firmly against each other due to the compression of pads 26 and 28 between faces 34 and 36 and faces 30 and 32 of panel 12, and panel 12 is held firmly between parallel faces 34 and 36 but without damage to panel 12. The angle “b” is made small enough (for example in the range between about 2 degrees and about ten degrees or preferably between about 2 degrees and about seven degrees) that the forces between faces 56 and 58 generate enough frictional resistance to sliding of parts 22 and 24 relative to each other that the clamp 10 remains assembled as in FIGS. 3 and 10 in normal use. In this way, panel 12 is clamped firmly between parallel clamp faces 34 and 36 without the use of fasteners such as bolts. The movement shown at FIG. 12C is completed when flange 52 abuts end face 150 of cavity 46, or when a flange 70 abuts an end face 152 of a channel 64, or when web 50 of formation 38 abuts an upper end of rib 68.

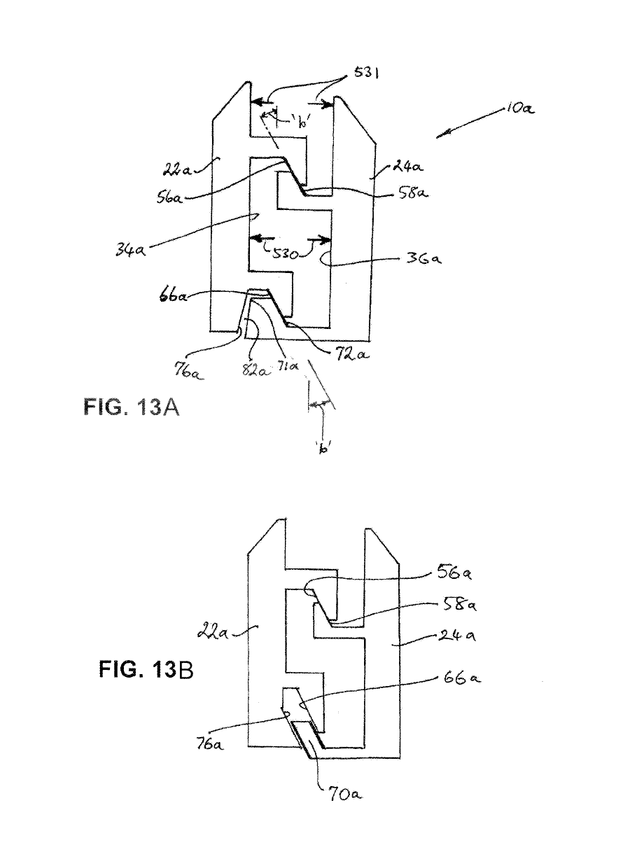

The way in which flanges 70 interact with part 22 during the movement in FIG. 12C and subsequently is described below with reference to FIG. 13A-B.

The above comments regarding angle “b” relates also to the angle “b” mentioned in the disclosures below of alternate clamp designs. Generally the intention is that a value be chosen for “b” that makes the clamps operate correctly (without for example their various parts separating) with the particular materials (including the resilient elastic pads) that are used.

Parts 22 and 24 are shown fully engaged with each other in FIG. 9, with a clearance gap 74 between rib 68 and floor 76 of cutaway 62, a clearance gap 78 between flange 52 and inner wall 80 of cavity 46, and a clearance gap 82 between flanges 70 and floor 76. Further there is a clearance gap 84 between parallel faces 86 and 88 of parts 22 and 24.

Rib 68 does not wedge between sidewalls 60 of cutaway 62, but does have clearances 94 therefrom—see FIG. 11. However, clearances 94 are sufficiently small so that the two clamp parts 22 and 24 align neatly.

It will be noted that the non-use of fasteners such as bolts to hold parts 22 and 24 and so clamp panel 12 allows greater freedom in the external shape of clamp 10 than is possible in other clamp types.

It will be further noted that any portion of the weight of panel 12 that bears down on the upper end of formation 38 tends to hold the two clamp parts 22 and 24 in engagement, when the clamp 10 is used in the upright position shown in FIGS. 2, 3 and 10. This is desirable from a safety point of view.

FIG. 13A is provided to clarify how clamp 10 works. FIG. 13A shows schematically a “clamp” 10a comprising a pair of laminae 22a and 24a that are movable in the plane of the page to interact with each other in essentially the way that clamp parts 22 and 24, respectively, of clamp 10 do. “Clamp” 10a is a schematic analog of actual clamp 10. Each item number in FIG. 13A with the suffix “a” corresponds in function (though not necessarily in exact shape) to the same item number without the suffix “a” in FIGS. 2-12. Thus for example lamina 22a corresponds to clamp part 22 and lamina 24a corresponds to clamp part 24.

Faces 56a, 58a and 66a and 72a are all angled at the small angle “b” (shown exaggerated) to clamping faces 34a and 36a, so that, if faces 56a and 58a are in contact and faces 66a and 72a are in contact, faces 34a and 36a move progressively closer to each other as lamina 22a is slid downwardly relative to lamina 24a while remaining parallel to each other. Arrows 530 schematically represent resultant forces applied to faces 34a and 36a to represent resultant forces that in clamp 10 would be developed due to the presence between faces 34 and 36 of panel 12 and resilient pads 26 and 28, and compression of pads 26 and 28. Faces 56a and 58a, and faces 66a and 72a, do press against each other while forces 530 act in the position shown, and friction between these pairs of faces resists any tendency of the laminae 22a and 24a to slide out of engagement with each other so that clamping action is maintained.

If instead the resultant forces due to clamping were to act at the higher positions shown by arrows 531, instead of the positions shown by arrows 530, the contact between faces 72a and 66a would be lost, and there would instead be contact between point 71a and face 76a. However, if clearance 82a is made suitably small, “clamp” 10a will still operate as a clamp in the way described above, when clamping forces are located as shown by arrows 531.

In practice, when clamp 10 is proportioned approximately as shown in FIGS. 2-10, the true position for the resultant clamping forces in use appears to be typically in the vicinity of formation 38, so that the clamping forces are mainly balanced by contact forces between faces 56 and 58 (or points thereof), with the contact forces between either faces 66 and 72 (or points thereon), or point 71 and face 76, as the case may be, being much smaller. Whether there is contact between faces 66 and 72 on the one hand or point 71 and face 76 on the other hand, or even an intermediate position, will depend on the precise position of the resultant forces developed by compression of pads 26 and 28. The clearance 82 is made small enough that if there is contact between point 71 and face 76, any deviation from parallelism between faces 34 and 36 will be inconsequential.

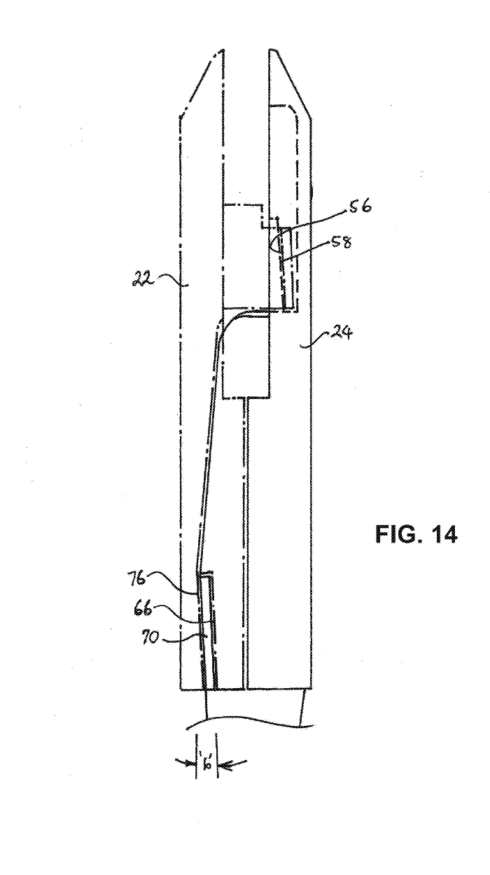

Instead of flanges 70 being of tapering thickness as shown in FIGS. 8 and 9, they may alternatively be of constant thickness, with the bottom face 76 of cutaway 62 being set at the angle “b” to face 34 over that part of its length in their vicinity. Such an alternative arrangement is shown in FIG. 14, which is otherwise identical to FIG. 9. Then, the space between each face 66 and face 76 would be a constant-width slot within which one of the flanges 70 could be received with small sliding clearance. This arrangement is also shown schematically in FIG. 13B, in which the same item numbering approach is used as in FIG. 13A. Assuming again a clamp proportioned similarly to clamp 10, the clamping forces (not shown) would be substantially balanced by contact between faces 56a and 58a (faces 56 and 58 in this version of clamp 10) with sliding movement of flanges 70a between faces 76a and 66a serving to maintain faces 34a and 36a substantially, if not necessarily exactly, parallel during clamp assembly.

Parts 22 and 24 of clamp 10 have undercuts and cavities and while able to be manufactured by a range of methods known in the art, such as machining from solid or die- or sand-casting with or without finish machining, lend themselves particularly to investment or “lost wax” casting. This can ensure that clearances such as clearance 82 for example can be kept small without the need for machining. Metals such as stainless steels are able to be formed using these latter methods, and can be suitable for architectural and external applications such as swimming pool fences. Exposed surfaces may be brought to a polished finish by known methods.

Note that the clamping mechanism described above depends on the compression of resilient elastic pads 26 and 28 and not on actual wedging of one of parts 22 and 24 into the other. Thus, if panel 12 is broken and is removed (e.g., knocked out) from between faces 34 and 36, the effects of the ceasing of compression of pads 26 and 28 and of clearances 74, 78, 82 and 84 are that part 22 can move slightly towards part 24 (e.g., tending to close gap 84) and pressure between faces 56 and 58 is broken so that friction between them does not greatly resist separation of parts 22 and 24.

This may be an advantage when a damaged fence must be repaired. The ability of part 22 to be moved towards part 24 after removal of panel 12 may allow part 22 to be broken away from grout 18 with little damage thereto and to be moved upward relative to supporting surface 14 and then fully out of engagement with part 24. Such upward movement may be initiated by placing a wedge-shaped tool (e.g., screwdriver end) between the curved upper end 90 of rib 68 and the bottom face 92 of formation 38. Although sidewalls 102 of clamp part 22 are shown in the Figures as parallel, their lower end portions could alternatively be slightly tapered (converging in a downward direction) to facilitate removal in the above manner after their initial grouting in place. A new panel 12 could then be placed on formation 38 (with a new pad 44 on formation 38) of part 22 and part 22 then mated again with part 24, compressing pads 26 and 28, without part 24 having to be removed from the grout 18. It is not asserted that this approach will always be possible, as the ability to use it will depend on the conditions at a particular site.

An alternative clamp 610 according to the invention, similar to clamp 10 in the way it clamps, will now be described. (A further clamp 710 with essentially the same clamping arrangement, but a different mounting arrangement, will then be described.)

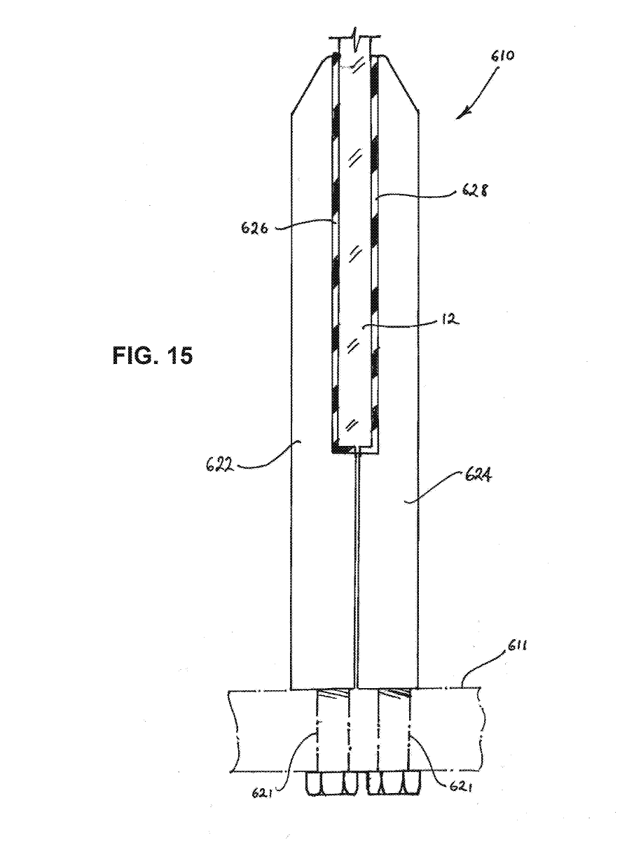

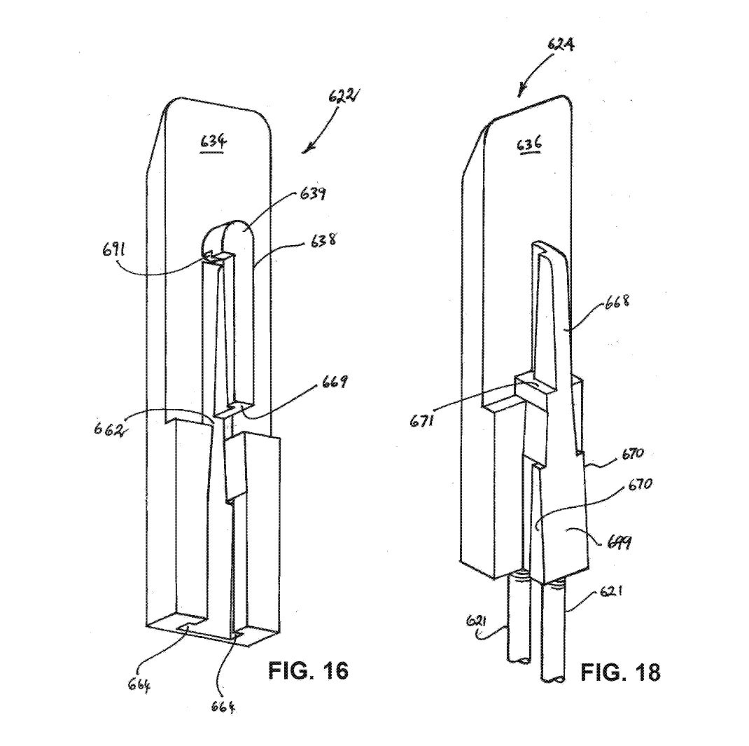

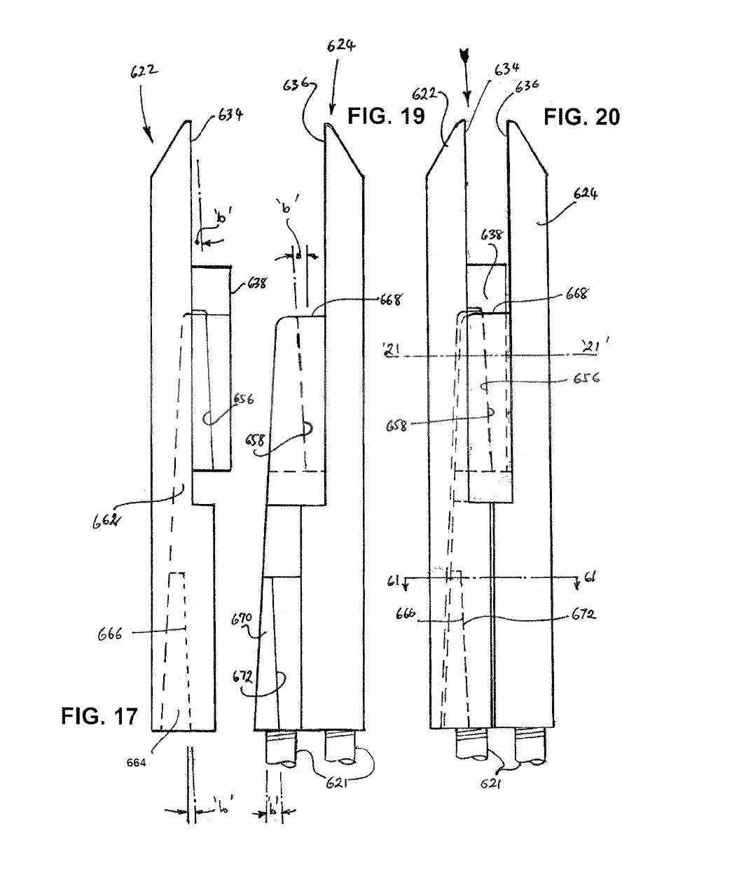

Clamp 610 is shown in FIG. 15 secured to a member 611 and holding panel 12 between resilient pads 626 and 628 similar to pads 26 and 28. FIGS. 16 and 17 show a first part 622 and FIGS. 18 and 19 show a second part 624 that are comprised in clamp 610. FIG. 20 shows parts 622 and 624 only, i.e. without pads 626 and 628, assembled together in the same way and view as FIG. 9 shows parts 22 and 24 of clamp 10 assembled together.

Clamp 610 differs from clamp 10 in two ways. First, instead of the formation 20 of clamp 10, clamp 610 has two bolts 621 screwed upwardly into second part 624. Bolts 621 (or other threaded members (not shown)) can themselves act as anchors grouted into a hole, or they can enable clamp 610 to be easily secured to a deck, beam or the like as represented by member 611 of FIG. 15.

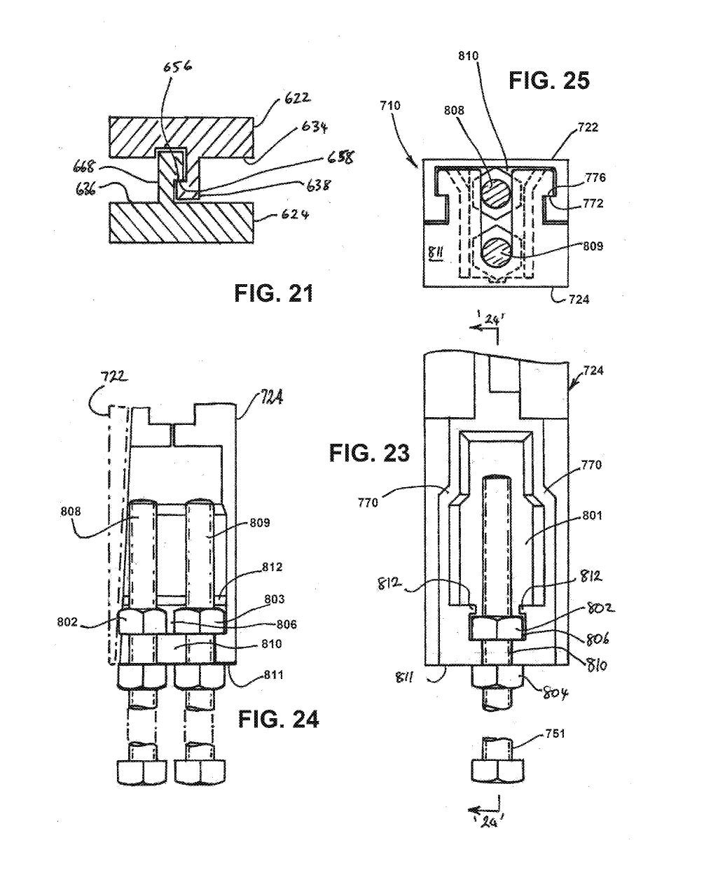

The second difference relates to the way the clamping principle is achieved. Although a pair of inclined faces 656 and 658 slide on each other during assembly, functioning as faces 56 and 58 do in clamp 10, the formations that support faces 656 and 658 differ from those in clamp 10 that support faces 56 and 58. Part 622 has a formation 638 protruding from clamping face 634 that during clamp assembly slides on a formation 668 that protrudes from clamping face 636 of part 624. Formation 668 is similar to the rib 68 of clamp 10 and on assembly is partly received in an elongate recess 662 in part 622. As best seen in FIG. 21, formations 638 and 668, where they overlap when clamp 610 is assembled, are L-shaped in cross-section and define faces 656 and 658. Faces 656 and 658 are at angle “b” to faces 634 and 636, as shown in the side views of FIGS. 17 and 19. Formation 638 has a rounded upper section 639 with a width approximately the same as the combined width of formations 638 and 668 when they are in engagement. Clamp 610 is assembled to a slotted edge 40 of a panel 12 in the same way shown in FIGS. 12A-C for clamp 10, with formations 638 and 668 being received in the slot 40 as formation 38 is received in the slot 40 in the case of clamp 10. During assembly of part 622 to part 624, faces 656 and 658 slide along each other. A U-shaped resilient elastic pad (not shown), like pad 44 of clamp 10, is placed over the rounded upper section 639 before assembly, is received neatly in the slot 40 in the panel 12, and carries out the same function as pad 44 does in clamp 10, namely to prevent direct contact between the panel 12 and upper section 639. When clamp 610 is used upright to clamp a bottom edge of a panel 12, the weight of the panel 12 supported on upper section 639 tends to hold clamp halves 622 and 624 together.

Flanges 670 having faces 672 are provided on part 624 and on assembly of clamp 610 are received in channels 664 of part 622 so that faces 666 of part 622 slide on faces 672 of flanges 670. Flanges 670 and faces 672 correspond in function to flanges 70 and faces 72 respectively of part 22 and channels 664 and faces 666 correspond in function to channels 64 and faces 66 respectively of part 24. Clamp 610 could also be varied (not shown) to have non-tapering flanges 670, in the same way, and for the same reasons, as described above in relation to clamp 10 by reference to FIG. 14 and FIG. 13B. End face 669 of formation 638 can contact face 671 of part 624 to act as a stop when the two parts 622 and 624 are fitted together as in FIGS. 15 and 20. Despite the geometrical differences, clamp 610 clamps a panel 12 in essentially the same way as clamp 10. Faces 656 and 658, as seen looking lengthwise of the clamp 610 (as in sectional view FIG. 21) may be parallel to faces 634 and 636, or may be at a slight angle to them (as shown in FIG. 21) so as to lock together in a hook-like manner.

A rounded face 691 on formation 638 is provided (see FIG. 16) to provide a recess into which a wedge (or screwdriver end) can be entered if panel 12 shatters and is broken away from between clamp parts 622 and 624 together with the rubber components to lift part 622 out of engagement with part 624.

A clamp (not shown) could of course be made that is like clamp 610 in having formations 638 and 668 as described above, but that has a different anchoring arrangement, such as for example an integrally formed anchoring formation (not shown) like formation 20 of clamp 10, instead of bolts 621.

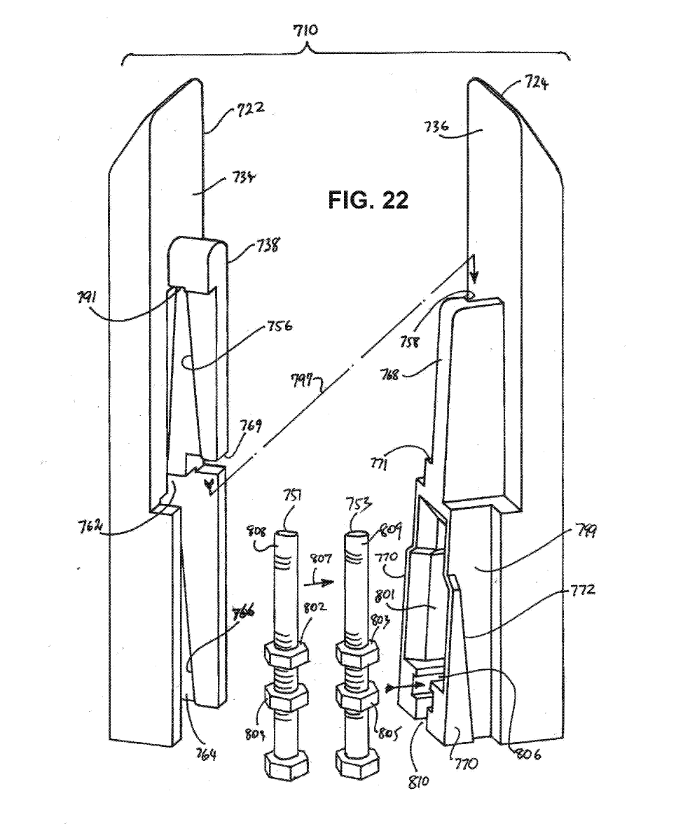

A clamp 710 generally similar to clamp 610, and clamping in the same way, but with still another possible anchoring arrangement will now be described. FIG. 22 is a perspective exploded view of clamp 710 which has two halves 722 and 724 and two mounting bolt assemblies 751 and 753 with which clamp 710 is used. Clamp 710 can clamp a panel such as panel 12 having an edge slot 40 in the same way as clamp 610. The following item numbers in FIGS. 22-25 indicate elements which are directly equivalent in their functions to elements of clamp 610 with item numbers that are the 100 less: 722, 724, 734, 736, 738, 768, 756, 758, 769, 771, 772, 766, 762, 770, and 764. Thus, for example, item 738 of clamp 710 engages with item 768 in exactly the same way as item 638 engages with item 668. Accordingly, part 722 can be moved into engagement with part 724 by movement as shown by arrow 797

Corresponding in clamp 710 to solid formation 699, which is an extension of element 668, is a wider but hollow formation 799. Formation 799 has an open-bottomed cavity 801 formed therein for receiving upper ends of bolt assemblies 751 and 753, by means of which clamp 710 can be conveniently secured to a substrate (not shown) or to a supporting member (not shown). Bolt assemblies 751 and 753 have nuts 802 and 803 respectively threadably received on bolts 808 and 809 together with nuts 804 and 805 as shown. Nuts 802 and 803 can be slidingly received in a channel 806 at the bottom of cavity 801 by being moved in the direction of arrows 807, with bolts 808 and 809 entering a slot 810. Flanges 812 prevent excessive upward and downward movement of nuts 802 and 803. Tightening of nut/washer sets 804 and 805 against a bottom face 811 of part 724 (which is easily possible because the width of channel 806 prevents nuts 802 and 803 turning therein) then secures bolt assemblies 751 and 753 in place partly in cavity 801 and partly extending below part 724. It is then possible for mating part 722 to be engaged with art 724 just as part 622 engages with part 624 in clamp 610. This arrangement avoids the need to provide threaded holes in part 724, and also has been found to be versatile and convenient for mounting part 724 and clamp 710 as required. The cavity 801 can be made long enough to accommodate a significant amount of longitudinal readjustment of the position of bolts 808, 809.

Clamp 710 is shown with flanges 770 that correspond to flanges 670 of clamp 610. Flanges 770 are shown as tapered, like flanges 670. However, just as flanges 670 can be made parallel instead of tapered (like the flanges 70 shown in FIG. 14) so too can flanges 770 be made parallel, with a corresponding modification of part 722, and for exactly the same reasons as stated above by reference to FIG. 13B.

It will be understood readily that the general way of anchoring described by reference to clamp 710 could be adapted to other clamps, for example the clamp 10. This anchoring arrangement is submitted to be inventive in itself.

A still further possible variation on clamp 610 will now be described. Installers of fences such as fence 1 desire to be able to adjust the position of glass panels, at least to a small degree, even after clamps such as 610 are secured in place. Specifically, they wish to be able to tilt a clamped panel (such as a panel 2 of fence 1) so that its upper edge can be moved slightly in a direction normal to the length of the panel. Because in clamp 610 reaction loads from the clamped panel onto the clamping parts 622 and 624 are largely resisted where they arise, by bearing of face 656 on face 658, lateral movement of flanges 670 within their receiving channels 664 requires (and can be resisted by) comparatively little force. Further, movement of flanges 670 within channels 664 corresponds to slight tilting of clamped panels. Therefore a degree of the desired form of adjustment can be secured by providing some clearance for lateral movement of flanges 670 in channels 664 and a means for causing and controlling such movement.

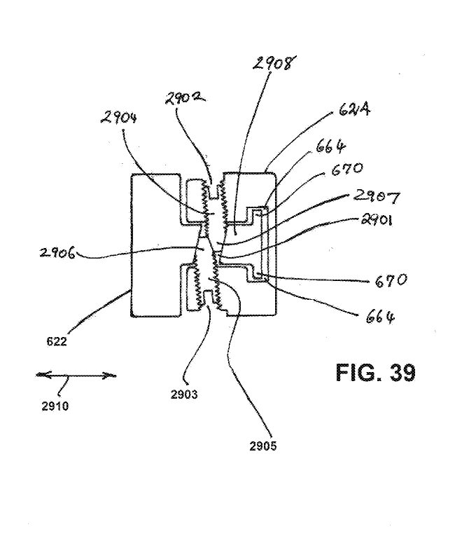

FIG. 39 shows a section through clamp 610 now modified in one way at a suitable position to provide the adjustment, the section location and orientation being shown as station ‘61-61’ on FIG. 20; Through fin formation 2908 which bears flanges 670, there is drilled, on a slant as shown, a hole 2901. In part 624 there are drilled and threaded two holes 2902 and 2903. These too may be on a slant as shown. Grubscrews 2904 and 2905 are placed in holes 2902 and 2903. They have tapered ends 2906 and 2907 that bear on each other within hole 2901. The effect of this arrangement is that fin formation 2908 can be moved through a small distance range in either of the directions of arrow 2910 by partially withdrawing one of screws 290 and 2905 and advancing the other. The effect of this in turn is to tile a clamped panel (not shown) slightly, as required. Screws 2904 and 2905 are much less obtrusive in appearance than the screws or bolts that pass through conventional clamps.

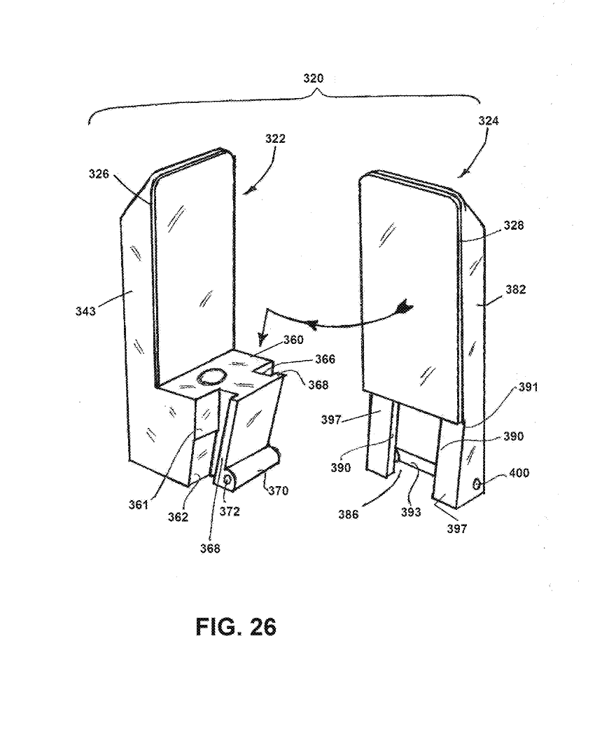

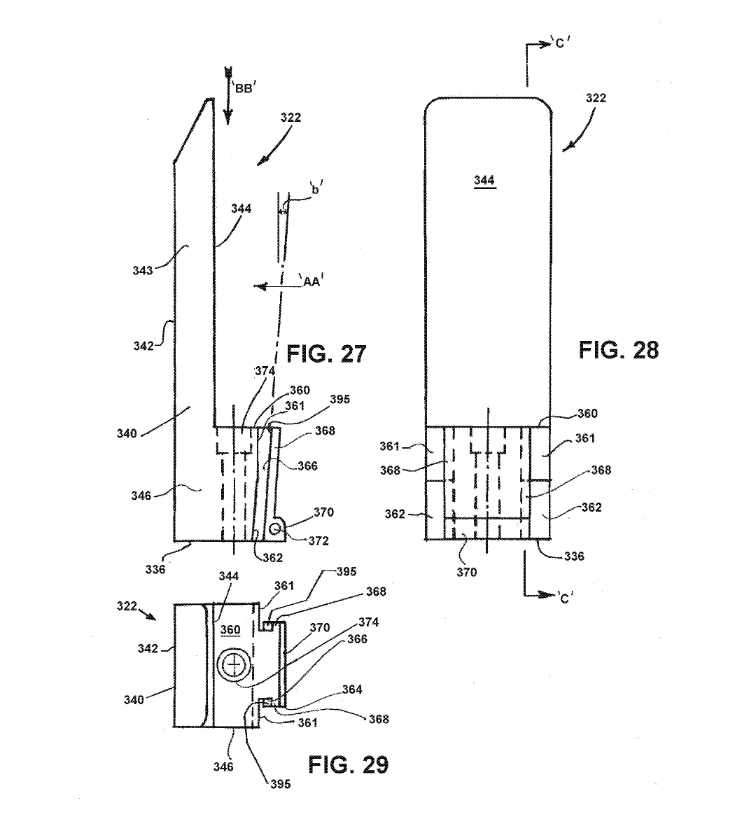

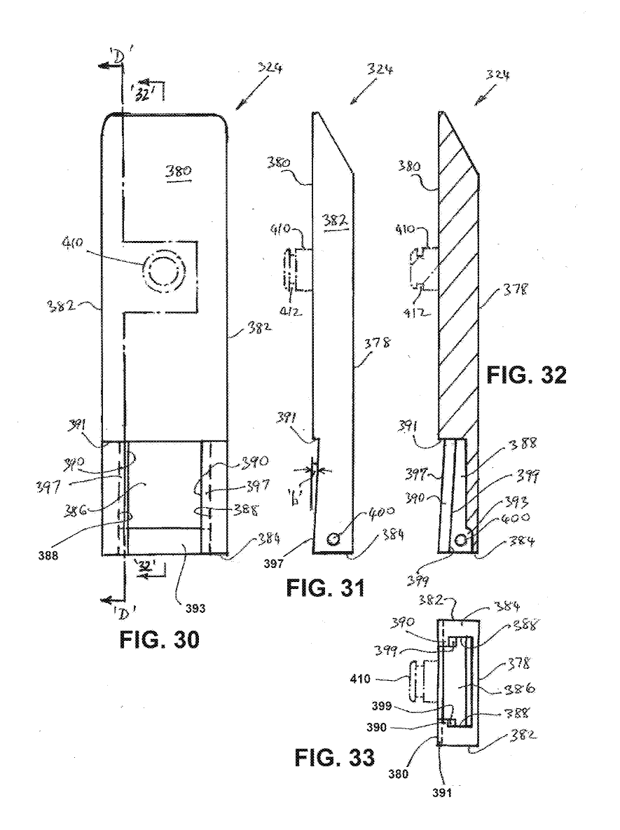

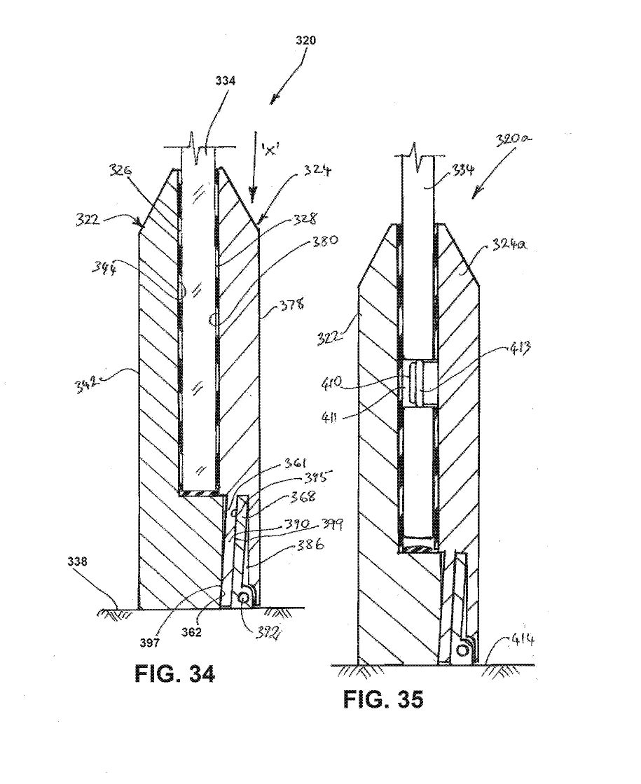

Another clamp embodying the invention will now be described. FIG. 26 shows in disassembled form a further clamp 320 according to the invention. Clamp 320 has a first clamp part 322 (see FIGS. 27-29) and a second clamp part 324 (see FIGS. 30-33) that in use co-operatingly mates with clamp part 322 and secured to clamp parts 322 and 324 respectively, elastic resilient pads 326 and 328. FIG. 34 shows clamp 320 in cross section when assembled and holding a glass panel 334 and illustrates the interlocking of the two parts 322 and 324.

FIG. 34 also shows the resilient pads 326 and 328 that in use are positioned between surface 344 and panel 334 and between surface 380 and panel 334 respectively. Their purpose is to distribute pressure on clamped glass panel 334 evenly and so to avoid damage due to direct contact between the glass panel 334 and the parts 322 and 324.

Clamp part 322 has a bottom face 336 that in use abuts a supporting surface 338 on which clamp 320 is to be secured. A main body 340 extends upward from bottom face 336 and has an outer face 342, side faces 343, and a clamping face 344. In use, resilient pad 326 lies against (and as stated above may be adhered to) face 344. A lower section 346 has an upper face 360 and faces 361 (coplanar with each other) that are parallel to face 344 and extend downward from face 360. Intersecting face 361, and at an acute angle “b” thereto, are locking faces 362.

Protruding outward from faces 361 and 362 of lower section 346 is a formation 364 that has a web 366 and flanges 368 that protrude laterally therefrom. At a lower end of formation 364 is a fillet-shaped extension 370 with a hole 372 extending therethrough. Flanges 368 are of constant thickness and are substantially parallel to faces 362 when seen in the side view of FIG. 27.

A stepped hole 374 extends between upper face 360 and bottom face 336 and can accommodate a socket-head fastener such as a bolt or screw (not shown).

Second clamp part 324 has an outer face 378, an inner, clamping face 380, and side faces 382. When parts 322 and 324 are interlocked with each other as described below, clamping face 380 is parallel to clamping face 344. Elastic resilient pad 328 (see FIG. 34) in use lies against clamping face 380 and against glass panel 334 and, like pad 326, has the purpose of evenly distributing clamping pressure onto panel 334 so as to avoid damage to panel 334.

Extending upwardly from a bottom face 384 is a cutaway channel 386 with sidewalls 388. Flanges 390 extend along sidewalls 388 and towards each other from sidewalls 388. Flanges 390 are of constant thickness as seen in FIG. 32, and are at an angle “b” to face 380.

At the upper end of flanges 390 is a shoulder 391.

A formation 410 that is optional is shown in chain-dotted lines in FIGS. 30-33. Its purpose when used will be described later.

FIG. 34 shows how clamp parts 322 and 324 (without optional formation 410) can interlockingly engage with each other and clamp a glass panel 334. By urging part 324 in the direction of arrow “X” relative to part 322, that part of formation 364 including flanges 368 can be slidingly received in channel 386. This is done with pads 326 and 328 in their respective positions against faces 344 and 380 and with panel 334 between pads 326 and 328. For flanges 390 to be received between flanges 368 and faces 361 and 362 to the point where shoulder 391 of part 324 abuts face 360 of part 322, it is necessary for pads 326 and 328 to be compressed, so clamping panel 334 between them. The effect of this compression is that faces 397 of flanges 390 press against faces 362 of part 322 (but clear faces 361) and faces 399 of upper portions of flanges 390 press sufficiently hard against faces 395 of flanges 368, that there is a frictional resistance to separation of parts 322 and 324. Holes 400 in part 324 and a hole 372 in part 322 also register with each other. Preferably, the application of some force or impacts (e.g., from a mallet) is required to bring the two parts 322 and 324 into their designed positions as shown in FIG. 34, with pads 326 and 328 under an appropriate degree of compression to clamp panel 334 without damage thereto. The holes 372 and 400 are optional and allow a pin (not shown) which may be a spring-type dowel or pins or a screw, to be passed through holes 400 in part 324 into hole 372 in part 322 to more positively lock parts 322 and 324 together. Such pin(s) or screw can be small (and for pins, flush with sidewalls 382) and so much less obtrusive than the comparatively large fasteners used to apply clamping force between jaws of some known clamps.

If part 324 has the optional formation 410, such a modified second clamp part being designated 324a, a modified form of clamp 320, designated clamp 320a and shown in FIG. 35, is obtained. (FIG. 35 is exactly equivalent for clamp 320a to FIG. 34 for clamp 320.) Like clamp 10 and unlike clamp 320, clamp 320a provides positive location of panel 334 within the plane of the panel 334. Formation 410 is adapted to be received in an opening 411 of panel 334 to provide such positive location. A range of shapes is possible for formation 410, but the particular one shown in FIGS. 35 and 30-33 has a circular cross-section with a peripheral groove 412 for an O-ring 413. O-ring 413 provides a cushion against direct contact between panel 334 and clamp part 324a to prevent damage to panel 334. Clamp 320a interlocks and clamps in the same way as clamp 320 save for the action of formation 410, so reference may be had to FIG. 34 and its supporting disclosure above. It will be noted that formation 410 of part 324a must be placed into opening 411 before parts 324a and 322 can clamp panel 334.

Other shapes and forms of formations may be used to obtain the functionality of formation 410. For example, a formation (not shown) like formation 38 of clamp 10 could be provided, and would suit a panel 334 having a slot-type opening (not shown) rather than the circular opening 411.

It is to be noted that formation 410 is provided on second clamp part 324a of clamp 320a rather than first part 322. When clamp 320a is used in the upright position shown, on a supporting surface 414, the result is that the weight of the panel 334 tends to hold parts 322 and 324a in engagement with each other, that weight being applied through formation 410. This principle is the same as the one discussed above, whereby formation 38 of clamp 10 was placed on second clamp part 24 rather than first clamp part 22.

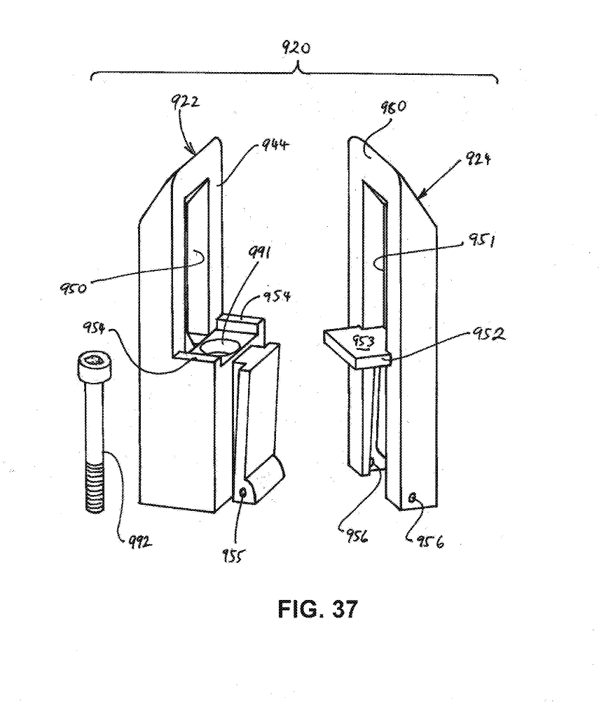

FIG. 37 shows in disassembled form another clamp 920 that embodies this last principle in a different way, but otherwise clamps in the same way as clamp 320. Clamp 920 has a first clamp part 922 and a second clamp part 924 that in use co-operatingly mates with clamp part 322 in the same way that parts 322 and 324 of clamp 320 mate so as to clamp a glass or other panel (not shown).

Clamping faces 944 and 980 of parts 922 and 924 respectively are intended to have elastic resilient pads (not shown, but corresponding to the pads 326 and 328 of clamp 320) against them to prevent direct contact with the surfaces of a clamped panel and to carry out the same part of the clamping function as pads 326 and 328 of clamp 320. (Specifically, clamp parts 922 and 924 are not proportioned to wedge one into the other, but to be held together frictionally due to the forces generated by compression of the resilient elastic pads during engagement of the parts 822 and 924.)

Clamp parts 922 and 924 have hollows 950 and 951 to reduce the amount of material required to make them (for example by investment casting in metal). Provided faces 944 and 980 are left with sufficient area (as is found possible in practice) there need be no excessive pressures on the clamped panel's surfaces.

Further clamp part 924 has a protruding ledge 952 on which in use of the clamp 910 an edge of the panel being clamped is supported (directly or more preferably by a resilient pad (not shown)) on upper surface 953 of ledge 952. This has the effect of causing the weight of the panel to hold parts 922 ands 924 in engagement, when the clamp 910 is used in the upright manner shown in FIG. 37 to support a lower panel edge.

Ledge 952 is received neatly and slidingly between raised formations 954 on part 922 to help keep the two parts 922 and 924 neatly in alignment with each other.

As an option, the two parts 922 and 924 are provided with holes 955 and 956 respectively through which can be passed a pin, dowel, screw or the like (not shown) to lock the parts 922 and 924 positively together in their fully engaged configuration.

Clamp part 922 is shown with a stepped hole 991 extending through it and in which can be received a screw 992 whereby part 922 is secured to a floor, deck, grouted-in ground anchor or the like (not shown).

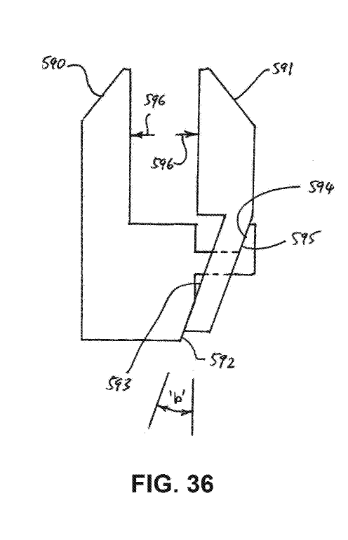

FIG. 36 is provided to enable comparison and contrasting of the clamping principles underlying clamps 10, 320 and 320a. It may be compared with FIG. 13A-B which refers to clamps 10 (and 710).

FIG. 36 shows two laminae 590 and 591 that are analogous respectively to the parts 322 and 324 of clamp 320 in the same way as in FIG. 13A parts 22a and 24a are analogous to parts 22 and 24. Faces 592 and 593 are analogous to the pair of faces 362 and 397 (lower portion) and faces 594 and 595 are analogous to the pair of faces 395 and 399. Arrows 596 are analogous to forces developed in the actual clamp 320 due to compression of resilient elastic pads 326 and 328 between parts 322, 324 and panel 334. FIG. 36 illustrates the clamping principle of clamp 320.

The distinction between clamps 10 and 320 lies in the relative positions of the forces (arrows 530 and 596) and the pairs of abutting faces at which reaction forces are developed that maintain the clamp parts in engagement with each other and clamp the panels.

Note that clamp parts 22 and 24, and clamp parts 322 and 324 are not wedged into each other, in the sense of being pushed into a gap between two converging surfaces—in the absence of resilient elastic pads 26 and 28 and 326 and 328, there is no clamping action.

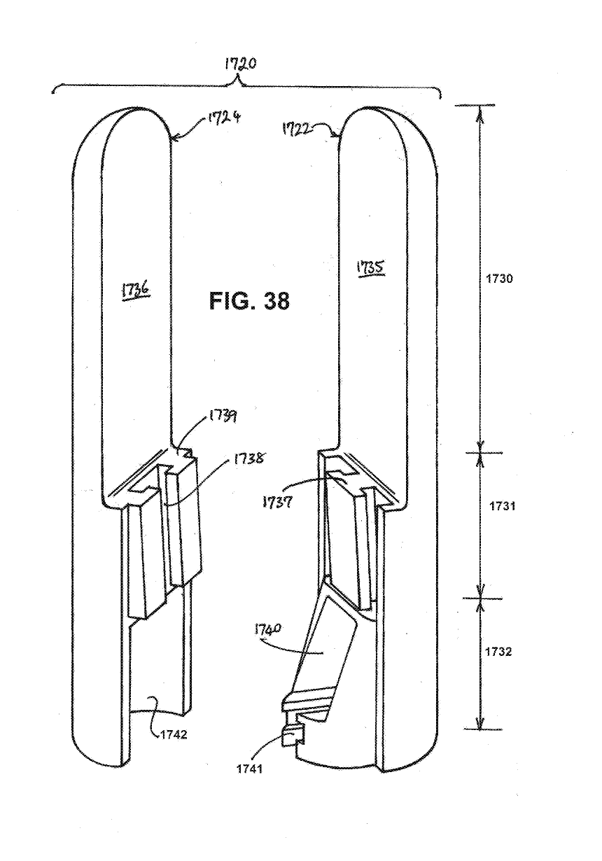

It is to be noted that the clamping principle of the clamps 320 and 920 can be combined with various methods of mounting clamps to decks or floors or within ground masses. FIG. 38 shows, disassembled, two clamping parts 1722 and 1724 of a clamp 1720 that is an example of this, inasmuch as the mounting arrangement of clamp 710 is combined with the clamping arrangement described by reference to clamp 320. Clamp 1720 has three distinct portions 1730, 1731, and 1732 (shown in the Figure by reference to part 1722). Parts 1722 and 1724 correspond to parts 322 and 324, respectively, of clamp 320. In portion 1730, they have faces 1735 and 1736 that correspond respectively to clamping faces 344 and 380, and that have the same function.

In portion 1731, clamp part 1722 has a formation 1737 that corresponds in function to formation 364 of clamp 320. That is, it is slideable into a shaped channel 1738, as parts 1722 and 1724 are assembled together in the same way as parts 322 and 324, the sliding occurring at a small angle to the length of the clamp 1720. To assemble clamp 1720 onto a panel (not shown) the panel's edge is supported on (or preferably slightly above) surface 1739 of part 1724 and formation 1737 is firstly slid and then driven into channel 1738 as elastic pads (not shown, but corresponding to pads 326 and 328) abutting faces 1735 and 1736 are compressed.

In portion 1732, part 1722 has a cavity 1740 and a slot 1741 that correspond respectively to cavity 801 and slot 810 of clamp 710 so that mounting bolts or anchors (not shown but analogous to bolts 808 and 809) can be positioned and secured therein in the same way as in clamp 710. As parts 1722 and 1724 are slid and driven into engagement with each other, a lower part-cylindrical wall 1742 covers the cavity 1740 and slot 1741.

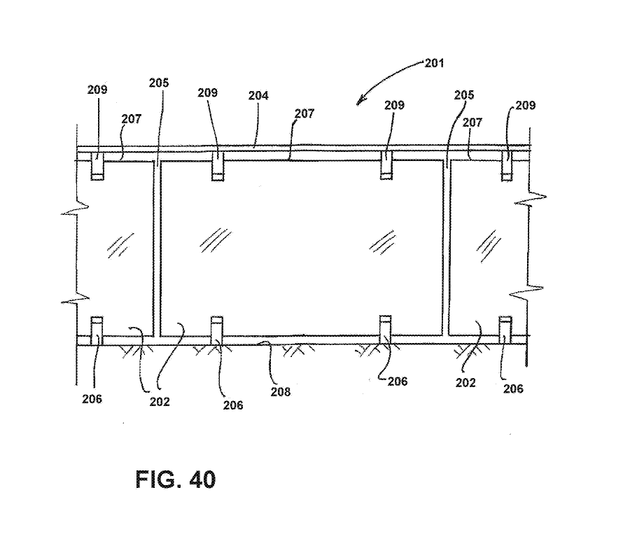

Clamps such as 320 and 920 and the variations on them described above are suitable for application to fences such as fence 1 but, like clamp 10, may also be used on other types of fences or barriers. FIG. 40 shows a fence 201 that is similar to fence 1, having panels 202 (for example only, of glass) arranged end-to-end but with gaps 205 therebetween and each supported on a substrate 208 by several clamps 203 (which could be of the type of clamp 10 or clamps 320 or 920), but differs in having an elongate rail assembly 204 that is secured to one or several adjoining panels 202 by further clamps 209 positioned on their upper edges 207. Clamps made on the principles described above, and in particular clamp 10, could also be used for clamps 206. Although not shown, rail assembly 204 may optionally be anchored to a structure (for example at its ends) as opposed to being supported entirely through panels 207 and clamps 209. It has been found that fence 201 can advantageously be applied as a balustrade for decks and balconies of buildings. It is considered that the fence 201 is inventive in itself, whether or not clamps made in accordance with the present invention are used in fence 201. The clamps described herein lend themselves to being secured to panels before being secured to a structure or substrate, and it has been found that this can be convenient for installers of fences, balustrades and the like.

Other embodiments and variations, within the scope of the described invention, will in the light of the above description readily suggest themselves to persons skilled in the art.

The specification of Australian Provisional Patent Application No. 2008903013, filed 14 Jun. 2008, is hereby incorporated in this specification by reference.

1-17. (canceled)

18. A clamp securable to a panel, said clamp extending longitudinally between top and bottom clamp ends and comprising:
a first clamp part that comprises a first clamping surface adjoining the top clamp end;
a second clamp part that comprises a second clamping surface adjoining the top clamp end and facing the first clamping surface across a gap therebetween;
a longitudinally elongate fastener of which an upper section is received in an internal cavity in the clamp and of which a lower section protrudes below the first and second clamp parts
wherein:
the internal cavity has an opening to the clamp exterior at its lower end through which the elongate fastener passes and above the opening is defined by a recess in the first clamp part and by a portion of the first clamp part that faces the recess;
the opening comprises a first slot extending laterally in a direction normal to the clamping surfaces the elongate fastener being slidingly received in the slot; and
upwardly facing lands within the recess extend outwardly from each side of the slot immediately above the first slot,
and further wherein:
one of the first and second clamp parts comprises formations protruding laterally outward on opposite sides of that clamp part and the other clamp part comprises grooves on opposite sides of the said other clamp part within which grooves the formations are slidingly received;
the grooves extend upwardly at an acute angle to the clamping surfaces so that the second clamp part is slideable longitudinally relative to the first clamp part into a non-clamping position where the recess is uncovered and the first and clamping surfaces move apart during such sliding.

19. The clamp of claim 18 wherein:
the fastener comprises a bolt threadably engaged with a nut;
the bolt is received in and slideable normal to its length along the first slot; and
the nut is slideably received within a channel in the recess that extends normal to the clamping surfaces and the nut bears on the lands immediately above and extending outwardly from each side of the first slot, the channel having a wall parallel to and close enough to the first slot to prevent rotation of the nut.

20. The clamp of claim 19 wherein the first clamp part comprises downwardly facing lands in the recess and therebetween a second slot parallel to the first slot along which the bolt is slideable the downwardly facing lands being spaced above the upwardly facing lands sufficiently for the nut to be received between the upwardly facing lands and the downwardly facing lands thereby to limit longitudinal movement of the nut in the clamp.

21. The clamp of claim 19 wherein the channel is open at one end whereby when the recess is uncovered in the non-clamping position the nut is movable laterally into the channel

22. The clamp of claim 19 wherein the first slot is open at one end whereby when the recess is uncovered in the non-clamping position the bolt is movable laterally into the first slot.

23. The clamp of claim 18 wherein the second clamp part comprises a surface within a gap between the first and second clamping surfaces that faces upwardly to provide support for a panel that is to be clamped in the clamp.

24. The clamp of claim 18 wherein each clamping surface has thereon an elastic resilient pad and the gap between the first and second clamping surfaces is so sized that that each pad is compressed when a panel is clamped in the clamp.
